(19) United States
(12) Patent Application Publication
(10) Pub. No.: US 2007/0065583 A1
(43) Pub. Date: Mar. 22, 2007

(54) Method for making decorative sealing strips

(76) Inventor: C. T. Chiou, Taipei Hisen (TW)

Correspondence Address: C.T. CHIOU, 235 Chung - Ho, Box 8-24, Taipei, TW

(21) Appl. No.: 11/230,616

(22) Filed: Sep. 21, 2005

(51) Int. Cl. B05D 5/00

(52) U.S. Cl. 427/256

(57) ABSTRACT

A method for making decorative sealing strips comprises the steps of material preparation, material feeding, thickness adjustment, drying, cooling, stereo pattern making, shaping and protective surface treatment, whereby an aluminum plate or a metallic plate will be firstly wholly coated by a layer of solvent-based thermal plastic resin, a second layer of acrylic plastic of various thicknesses on its outward surface and a third layer of transparent protective film. A sealing strip thus made possesses a stereo pattern, being further beautified by the reflective effect of the protective film. Therefore, the edge of an article applied with the sealing strip will be more visually appealing.

### FIELD OF THE INVENTION

The present invention relates to methods for making decorative sealing strips, more particularly to a method for making decorative sealing strips enclosing an aluminum film or a metallic film having a stereo pattern.

### BACKGROUND OF THE INVENTION

Sealing strips, applied to storage cabinets consisting of planar boards, made by the conventional method for making decorative sealing strips decorate the edges of the planar boards so that the sharp angles can be hidden. However, the boards made of regular wooden materials are costly to make, and therefore they are replaced by reinforced ornamental plates that are composite plates coated with a thick plastic layer. Since they belong to hard boards, the side surfaces thereon cannot be effectively decorated and sealed.

Further, some manufacturers in this field utilize aluminum plates to decorate the edges of future pieces or other articles. Since the surfaces of the aluminum plates are susceptible to oxidation so that the metallic reflection thereon is shadowed, they have be treated to resist the oxidation. Therefore, the cost is high and the production process is complicated. Further, since the surface of an aluminum plate is flat, it is costly to apply a stereo pattern to the plate. Therefore, aluminum plates used as sealing strips are usually provided without a stereo pattern.

### SUMMARY OF THE INVENTION

Accordingly, the primary objective of the present invention is to provide a method for making decorative sealing strips, whereby a stereo pattern can be applied easily, quickly and cheaply on a surface of a sealing strip. Therefore, an extra visually appealing effect can be added to the sealing strip, and the edge on which the strip is decorating will be more beautiful.

The various objects and advantages of the present invention will be more readily understood from the following detailed description when read in conjunction with the appended drawings.

### BRIEF DESCRIPTION OF THE DRAWINGS

FIG. 1 is a perspective view of a sealing strip made of the method for making decorative sealing strips of the present invention.

FIG. 2 is a cross-sectional view of the sealing strip in FIG. 1.

FIG. 3 is another perspective view of a sealing strip made of the method for making decorative sealing strips of the present invention, wherein the stereo pattern is different from that of the previous one.

FIG. 4 is further perspective view of a sealing strip made of the method for making decorative sealing strips of the present invention, wherein the stereo pattern is different from that of the previous one.

FIG. 5 is the application of a sealing strip made of the method for making decorative sealing strips of the present invention to a table.

FIG. 6 is a flow chart for the method for making decorative sealing strips.

FIG. 7 is a system diagram illustrating the method for making decorative sealing strips.

### DETAILED DESCRIPTION OF THE PREFERRED EMBODIMENTS

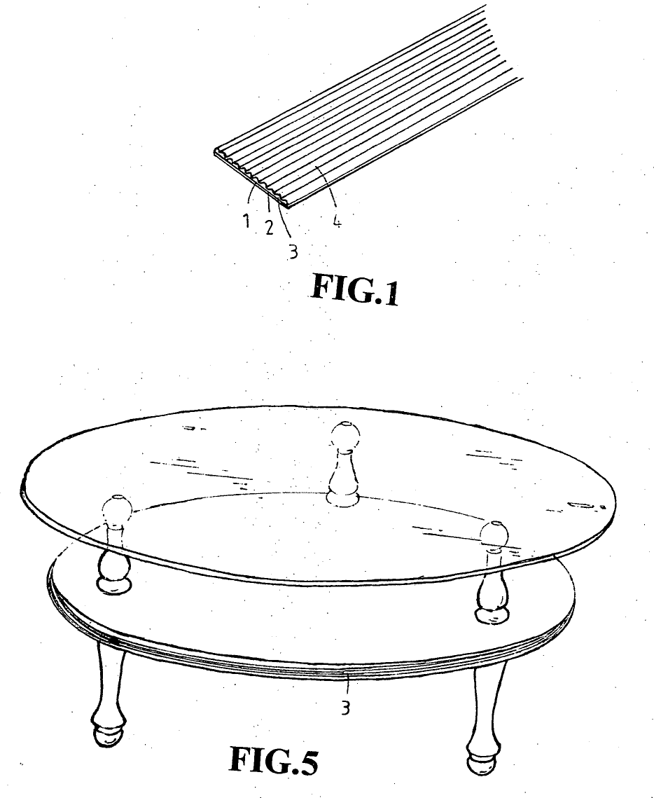

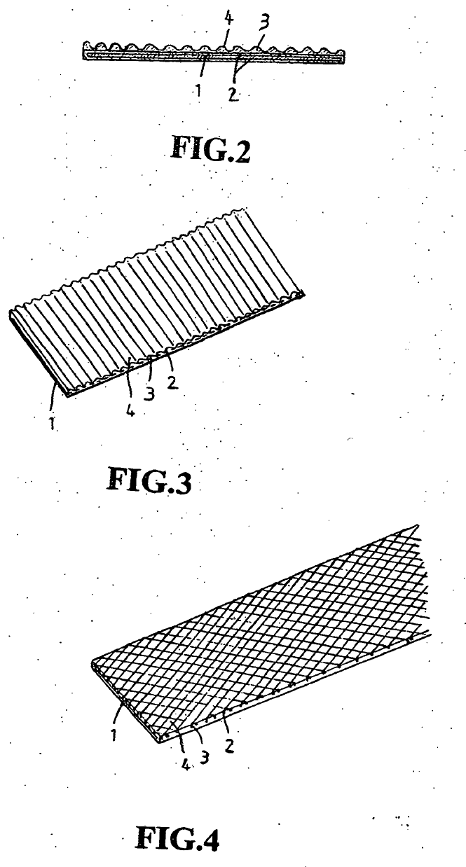

Referring to FIGS. 1 and 2, a method for making decorative sealing strips relates to sealing strips made of aluminum or metallic plates. The structure thereby produced comprises a substrate material 1, made of an aluminum plate or a metallic plate, coated with a layer of solvent-based thermal plastic resin 2 on every surface thereof. Further, another layer of acrylic plastic 3 of various thicknesses is applied on the outer surface of the substrate material 1. The acrylic plastic 3 can be selected from a transparent resin or a colored resin. In addition, a layer of transparent protective film 4 is applied on the layer of acrylic plastic 3, whereby the optical reflection by the surface of the acrylic plastic 3 through the protective film 4 will form a visually appealing stereo pattern. The process is of low production cost, and the flexibility of using various colors in the protective film 4 may produce colorful stereo patterns, which cannot be achieved by metallic strips alone. Therefore, sealing strips for decorating an edge of an article can be more practical and beautiful.

Referring to FIGS. 3 and 4, the flexibility of using layers of acrylic plastic 3 of various colors and different thick arrangements can further provide the associated sealing strips with different stereo patterns and colors. Since the outer surface of the aluminum plate used as the substrate material 1 is coated by a layer of acrylic plastic 3 and a protective film 4, the surface is very flexible and so firm as to resist wearing out. Even if the sealing strips are damaged, they can be fixed by a risen material. The sealing strip thus made can be applied to various objects, such as a table board, a chair seat, a kitchen table, a bar table, a wine storing cabinet, a book shelf, a desk . . . . As shown in FIG. 5, the stereo and colorful pattern of a sealing strip thus made can make an article it applied to look beautiful and more valuable. Especially, the flexibility of choosing colors makes a sealing strip made by the present invention more adaptive to various occasions of application.

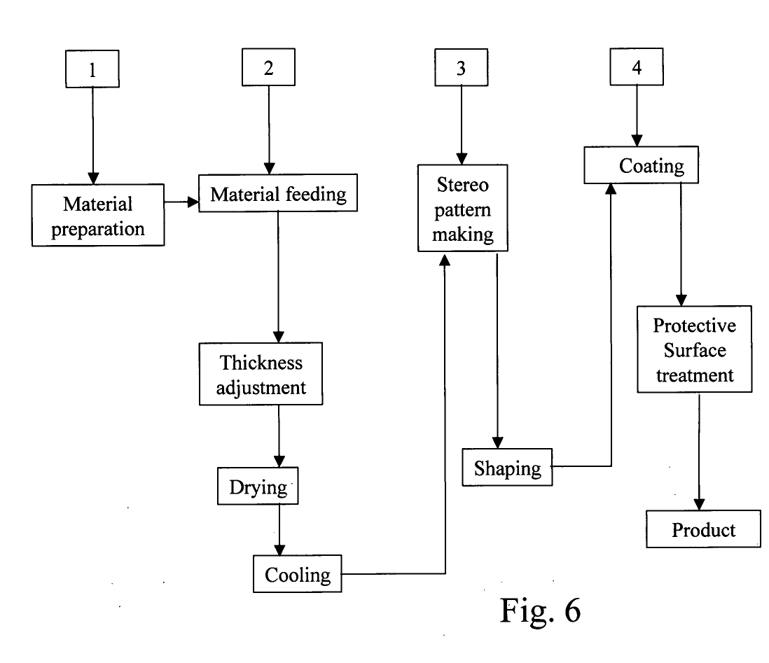

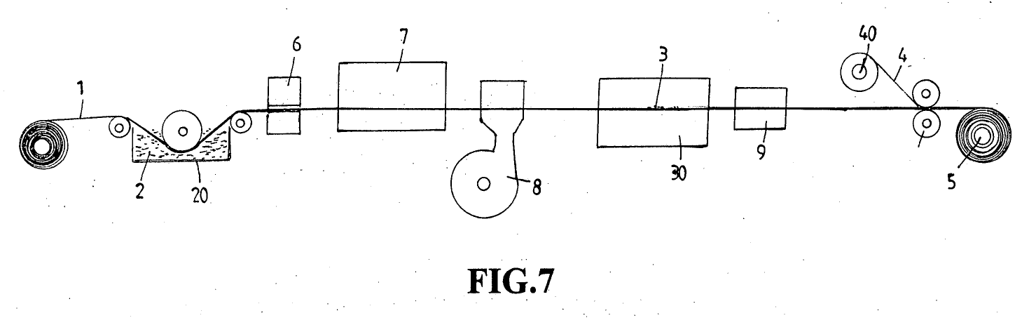

Referring to FIGS. 6 and 7, the method for making decorative sealing strips comprises the steps of:
(1) material preparation: placing an elongated substrate material 1 in a material feeder or a material roller 5 of the production system. Meanwhile, inject liquid solvent-based thermal plastic resin 2 and acrylic plastic 3 respectively into a thermal plastic resin tank 20 and an acrylic plastic treatment tank 30. The protective film 4 is placed on a coater 40.
(2) material feeding: the substrate material 1, a metallic plate or particularly an aluminum plate, being transported by the roller 5 to be immersed in the thermal plastic resin tank 20, whereby the substrate material 1 will be coated by an layer of solvent-based thermal plastic resin 2. The solvent-based thermal plastic resin 2 not only protects the surface of the substrate material 1 but also plays the role of a mediating medium for the second layer of another material.
(3) thickness adjustment: adjusting the thickness of the layer of the solvent-based thermal plastic resin 2 on the surface of the substrate material 1 by a thickness adjusting means.
(4) drying: dry the layer of the solvent-based thermal plastic resin 2 quickly by sending the substrate material 1 into a drying treatment device heated at 200-300° C.
(5) cooling: the layer of the solvent-based thermal plastic resin 2 on the substrate material 1 just treated by the drying device is cooled in a cooling device.
(6) stereo pattern making: after the substrate material 1, a metallic plate or particularly an aluminum plate, being sufficiently cooled, the feeder continues to transport it into the acrylic plastic treatment tank 30 for coating an outer surface of the substrate material 1 with another layer of the acrylic plastic 3.
(7) shaping: forming a predetermined stereo pattern onto the layer of acrylic plastic 3 on the substrate material 1, a metallic plate or particularly an aluminum plate, by a shaping device.
(8) protective surface treatment: after the stereo pattern is formed on the outer surface of the substrate material 1, the layer of the acrylic plastic 3 is then coated by the transparent protective film 4 so as to protect the layer of the solvent-based thermal plastic resin 2.

Further, the acrylic plastic 3 can be colored to provide colors to the stereo pattern so that the pattern can reflect a colorful metallic shining effect. Therefore, the present invention is even more visually appealing.

The processes of the present invention are sequentially done, and therefore neither one of them can be omitted. Further, the temperature control should be exactly done in order to achieve the desired stereo pattern.

As shown in FIG. 5, the consumption of raw materials of the present invention is little and cheap, but the sealing strips thereby made are durable and resistant to erosion. Further, they can provide a visually appealing effect to the edges of articles they decorate. Since the acrylic plastic 3 can be dyed with various colors, the stereo patterns produced by the present invention are colorful, therefore being capable of being applying to many occasions. For example, when applied to a brown coffee table, a cream-colored sealing strip can be used. In another example, a sealing strip of mixed colors can be used to provide an unconventional visual effect. To summarize, the method for making decorative sealing strips of the present invention not only seal the edge of an article with an anti-erosive material but also provide a colorful decoration.

The present invention is thus described, and it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for making decorative sealing strips, comprising the steps of: coating a metallic plate and particularly an aluminum plate with an layer of solvent-based thermal plastic resin or a layer of uneven acrylic plastic so as to form decorative sealing strips so that a surface of the metal plate has uneven three-dimensional structure.

2. The method for making decorative sealing strips as claimed in claim 1, wherein the metallic plate is an aluminum plate.

3. The method for making decorative sealing strips as claimed in claim 1, wherein said acrylic plastic is selected from a transparent risen and a colored resin.

4. A method for making decorative sealing strips, comprising the steps of:
(1) material preparation in which a substrate material is placed in a device selected from a material feeder and a material roller of a production system, and liquids of solvent-based thermal plastic resin and acrylic plastic are respectively injected into a thermal plastic resin tank and an acrylic plastic treatment tank; a transparent protective film being placed on a coater;
(2) material feeding in which said substrate material, selected form a metallic plate and particularly an aluminum plate, is transported by said roller to said thermal plastic resin tank for being marinated, thereby coating said substrate material with an layer of solvent-based thermal plastic resin; said solvent-based thermal plastic resin not only protecting a surface of said substrate material but also playing the role of a mediating medium for connecting a second layer of another material;
(3) thickness adjustment in which the thickness of said layer of said solvent-based thermal plastic resin on said surface of said substrate material is adjusted by a thickness adjusting means;
(4) drying in which said layer of said solvent-based thermal plastic resin is dried quickly, after sending said substrate material into a drying treatment device heated at a temperature of 200-300° C.;
(5) cooling in which said layer of the solvent-based thermal plastic resin on said substrate material just treated by said drying device is cooled in a cooling device;
(6) stereo pattern making in which said feeder continues to transport said substrate material into said acrylic plastic treatment tank for coating an outer surface of said substrate material with another layer of said acrylic plastic, after said substrate material is sufficiently cooled;
(7) shaping in which said layer of said acrylic plastic applied on said substrate material is pressed to form a predetermined stereo pattern thereon by a shaping device;
(8) protective surface treatment in which said layer of said acrylic plastic is then coated by said transparent protective film for a protective effect, after said stereo pattern is formed on said outer surface of said substrate material;
whereby said substrate material, selected from a metallic plate and particularly an aluminum plate, will be coated by said solvent-based thermal plastic resin on the whole exterior surfaces thereof, then said acrylic plastic on an outer surface thereof, and eventually said protective film, and whereby said layer of said acrylic plastic will be formed with a predetermined stereo pattern for beautifying a sealing strip made by said substrate material.

5. The method for making decorative sealing strips of claim 4, wherein said acrylic plastic is selected from a transparent risen and a colored resin.
